(19) United States
(12) Patent Application Publication
(10) Pub. No.: US 2016/0006185 A1
(43) Pub. Date: Jan. 7, 2016

(54) CONVERTER JACK

(71) Applicant: PHITEK SYSTEMS LIMITED, Newmarket, Auckland (NZ)

(72) Inventors: NIGEL GREIG, PT. CHEVALIER (NZ); WILLIAM JAMES SIM, T ATATU PENNINSULA (NZ); ROY MOODY, NEWMARKET (NZ); JASON KING, NEWMARKET (NZ)

(21) Appl. No.: 14/769,965

(22) PCT Filed: Feb. 24, 2014
(86) PCT No.: PCT/US2014/018117

§ 371 Date: Aug. 24, 2015

(30) Foreign Application Priority Data
Feb. 22, 2013 (NZ) 607478

(51) Int. Cl. H01R 13/66; H01R 27/02

(52) U.S. Cl. CPC H01R 13/665; H01R 27/02

(57) ABSTRACT

A converter jack facilitating communication between an in-flight entertainment (IFE) system and a consumer device, comprising: an input socket for receiving signals from the consumer device transmitted in one of a plurality of possible signal formats; a signal recognition sub-system for detecting the format of the received signals; and a signal conversion sub-system for converting the received signal to a format appropriate for the WE system; and an output for transmitting the converted signal to the IFE system.

### FIELD OF THE INVENTION

The present invention relates to aircraft passenger communication and entertainment systems, such as in-flight entertainment (“IFE”) systems. The invention has particular relevance to a connector or connection system for allowing user devices such as notebooks, tablets, mobile phones, smart phones, portable game systems and media player devices to be connected to, or used in conjunction with, IFE systems.

### BACKGROUND

In-flight entertainment (“FE”) systems are now commonplace on commercial passenger aircraft. Generally, aircraft manufacturers manufacture aircraft for a “wholesale” market which allows the airlines to make additions and changes to the aircraft fit-out to suit their requirements, including the addition or upgrade of IFE systems. Modern IFE systems generally comprise a personal video screen and audio interface provided in each seat of the aircraft, which communicate with and receive content from a single central IFE computer system.

IFE systems run the risk of rapidly becoming obsolete as passengers carry their own devices on aircraft. These devices may require only a suitable power supply or the passenger may desire access to features or content associated with the IFE system. Passengers may wish to view their own content on a personal video screen of the IFE system, or view on-demand or broadcast content of the IFE system on their own personal devices, for example.

Consumer devices are commonly shipped with a wide variety of connection types using different communication standards, including High-Definition Multimedia Interface (HDMI™), Universal Serial Bus (USB), Bluetooth® and/or Wi-Fi. An important consideration for aircraft environments is that wireless communications pose a technical and legal problem. Current IFE systems commonly lack HDMI or USB3.0 inputs and do not, or cannot, process high definition (HD) video data. A further complication is that consumer devices may use any one of a range of industry standard or proprietary physical connectors and/or native digital data formats, including Mobile High-Definition Link (MHL®) and Apple Inc.'s ‘Lightning™. In many cases where an adapter is provided it is only passive, changing the plug type but providing no signal conversion. The MHL standard, for example, is connector agnostic and may use both micro-USB and HDMI connectors, but uses MHL communication protocols rather than those defined by either the USB or HDMI standards.

An aircraft fit-out is expensive, so a new fit-out or upgrade of IFE systems may not be performed for several years or longer. In that time, customer requirements for connectivity to IFE systems is likely to have changed significantly. Apart from connector types, there is also the matter of replacement of worn or damaged connectors. If a seat connector, for example, is faulty then it is important to be able to replace it simply and quickly to avoid flight delays. It is hence important to have a means of supplying passengers with a socket to the IFE system that can allow the connection of their consumer devices.

### Objects of the Invention

It is an object of the invention to provide a new IFE converter jack which will at least go some way to overcoming disadvantages of existing systems, or which will at least provide a useful alternative to existing systems.

Further objects of the invention will become apparent from the following description.

### SUMMARY OF INVENTION

In one aspect the invention may broadly be said to consist in a converter jack facilitating communication between an in-flight entertainment (IFE) system and a consumer device, comprising:
an input socket for receiving signals from the consumer device transmitted in one of a plurality of possible signal formats;
a signal recognition sub-system for detecting the format of the received signals; and
a signal conversion sub-system for converting the received signal to a format appropriate for the IFE system; and
an output for transmitting the converted signal to the IFE system.

Preferably the signal recognition sub-system is adapted to classify the received signal into one of a plurality of predefined signal formats on the basis of one or more of:
signal voltage levels;
signal frequencies;
pin-outs;
trial and error of decoding algorithms; and/or user input.

Preferably the converter jack may be disconnected from both the consumer devices and the IFE system.

In at least one embodiment the converter jack comprises a single input socket. The single input socket is preferably able to receive high definition content. In one embodiment the input socket is a High-Definition Multimedia Interface (HDMI) socket. Alternatively, the input socket may comprise a USB 3.0 socket or similar. When the converter jack is not used on aircraft, a wireless transmission means may alternatively be used in place of the input socket.

Preferably the input socket is replaceable.

Preferably the signal recognition and/or signal conversion sub-systems are reprogrammable. In particular, in a preferred embodiment the converter jack is reprogrammable by the IFE system through a reprogramming port. Alternatively the converter jack may be reprogrammed by an external device or a device plugged into the input socket. Reprogramming may comprise defining one or more new possible signal formats and/or logic for classifying the same.

Preferably the output comprises analogue and/or digital outputs. The signals provided to the IFE system will depend on the capabilities of the IFE system. More particularly, one or more of the analogue and/or digital outputs comprise input/output ports, wherein the converter jack is adapted for two-way communication with the IFE system.

Preferably the signal recognition sub-system comprises logic to detect the format of the received signals.

Preferably the input socket comprises an input/output, wherein the converter jack is adapted for two-way communication with the consumer device.

Preferably the signal conversion sub-system is further adapted for converting a signal received from the IFE system to the format of signals received from the consumer device.

Preferably the converter jack further comprises a down-rendering subsystem to convert a high-bandwidth signal to a low-bandwidth signal. The high-bandwidth signal may comprise a High-Definition (HD) video signal, and the low-bandwidth signal may comprise a Standard-Definition (SD) video signal, for example.

Preferably the converter jack further comprises a digital-to-analogue converter (DAC) for converting a digital signal received from the consumer device to an analogue signal for output to the IFE system.

Preferably the converter jack further comprises an analogue-to-digital converter (ADC) for converting an analogue signal received from the IFE system to a digital signal for output to the consumer device.

Preferably the converter jack further comprises a power conversion subsystem to provide an appropriate power source for the consumer device. Power may be supplied to the consumer device via a cable connected to the input socket, or the converter jack may further comprise a power socket for connection to the consumer device.

Preferably the two-way communication may enable the IFE system to control, or provide feedback to, the consumer device. Preferably the converter jack is able to detect the format of the signals received from the IFE.

Preferably the signal conversion sub-system is able to convert the IFE signals to a format appropriate for the consumer device.

According to a second aspect, the invention may broadly be said to consist in an in-flight entertainment (IFE) system comprising a plurality of converter jacks according to the first aspect of the invention, each communicatively coupled to an IFE server system.

Preferably the IFE system may perform some of the processing associated with the converter jacks.

According to a third aspect, the invention may broadly be said to consist in an in-flight entertainment (IFE) system comprising:
an IFE server system; and
a plurality of remote converter jacks each comprising an input socket for receiving signals from a consumer device transmitted in one of a plurality of possible signal formats, and adapted to detect the format of the received signal from among the possible signal formats, and convert between each of the plurality of possible signal formats and an IFE system signal format to enable communication between the consumer device and the IFE server system.

Preferably the input sockets of the converter jacks are replaceable.

Preferably the converter jacks are reprogrammable.

According to a fourth aspect, the invention may broadly be said to consist of a method of interfacing between an IFE system and a consumer device comprising the steps of:
receiving signals from the consumer device transmitted in one of a plurality of possible signal formats;
detecting the format of the received signals;
converting the received signals to a format appropriate for the IFE system; and
transmitting the converted signal to the IFE system.

Preferably the method may be reversed to allow two-way communication between the consumer device and the IFE system.

The disclosed subject matter also provides connector apparatus or connection of methods which may broadly be said to consist in the parts, elements and features referred to or indicated in this specification, individually or collectively, in any or all combinations of two or more of those parts, elements or features. Where specific integers are mentioned in this specification which have known equivalents in the art to which the invention relates, such known equivalents are deemed to be incorporated in the specification.

Further aspects of the invention, which should be considered in all its novel aspects, will become apparent from the following description.

### DRAWING DESCRIPTION

A number of embodiments of the invention will now be described by way of example with reference to the drawings in which:

FIG. 1 is a system diagram of a first embodiment of a converter jack according to the invention.

FIG. 2 is a system diagram of a second embodiment of a converter jack according to the invention.

FIG. 3 is a model of a first embodiment of a converter jack according to the invention.

FIG. 4 is a model of a first embodiment of a converter jack according to the invention.

FIG. 5 is a system diagram of a first embodiment of a converter jack according to the invention.

FIG. 6 is a diagram of an IFE system showing a first embodiment of a converter jack according to the invention.

### DETAILED DESCRIPTION OF THE DRAWINGS

Throughout the description like reference numerals will be used to refer to like features in different embodiments.

Although the invention is described with particular reference to IFE systems for aircraft it is understood that similar entertainment systems on passenger craft such as buses, trains and ships would benefit from the use of the such converter jacks.

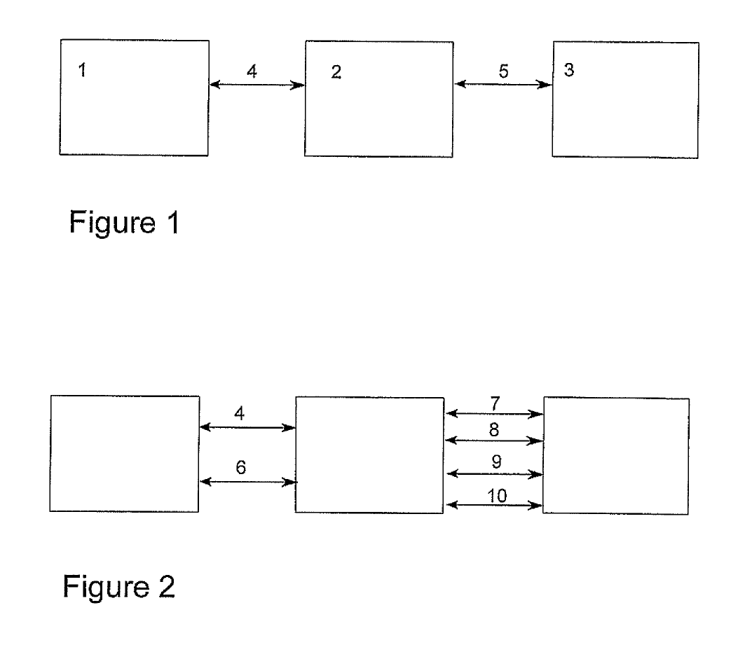

Referring first to FIG. 1 a high level system diagram shows a converter jack 2 associated with a consumer device 1 by communication means 4 and an IFE system 3 by communication means 5. The IFE system includes apparatus generally referenced 3 which comprises a central processor or server able to deliver media over cabling to one or more seat distribution units. The seat distribution units deliver the entertainment media to devices present in/on or in the vicinity of, each seat to make the media available to the user. The devices typically include a visual display unit such as an LCD screen (not shown) and a number of connection sockets which are mounted on or adjacent to each seat. The sockets may include a variety of connector types. For example, connector types may comprise a USB socket and a power socket. Currently there are limited consumer devices able to interface with the IFE systems and this is partly due to the inability of many devices to connect to the system. This inability arises because of the limited number of sockets available on or in the seat. Typically few options are provided because it is expensive to provide more, it creates more opportunity for breakages and rapidly developing technologies may supersede the sockets provided. This is particularly noticeable in the provision of High-Definition media content, where there are many competing signal protocols including High-Definition Multimedia Interface (HDMI), Universal Serial Bus (USB), Mobile High-Definition Link (MHL) and Lightning, among others. Although adaptor cables are available with connectors allowing physical connection of different devices, these cables often do not change the signal protocol format, leaving the devices unable to interface appropriately.

As outlined above in this document there is a wide array of output means from consumer electronic devices, This leads to a difficulty in specifying the connector types that are required and upgrading these over time as consumer electronics are upgraded in much faster cycles than IFE systems. Having individual connector jacks able to connect to single types of consumer devices is neither practical nor viable for IFE systems. FIG. 2 increases the detail shown by FIG. 1 by showing the presence of multiple communications between the converter jack 2 and consumer device 1 or IFE 3 (these connections may be contained in a single cable). In a particular embodiment the connections between the consumer device and the converter jack may comprise a separate data and power connections 4, 6. The cables and connectors may comprise an HDMI cable supplying data and a USB cable supplying power, for example.

FIG. 2 also shows a number of connections 7, 8, 9, 10 between the converter jack 2 and the IFE system 3. These may include, but are not limited to power, analogue ports, digital ports and universal serial bus (USB) connections. In some embodiments the communications may be multiplexed into a single communications channel. In a further embodiment the converter jack may also multiplex the data, power and other communications (including but not limited to control signals) between the consumer device and the converter jack.

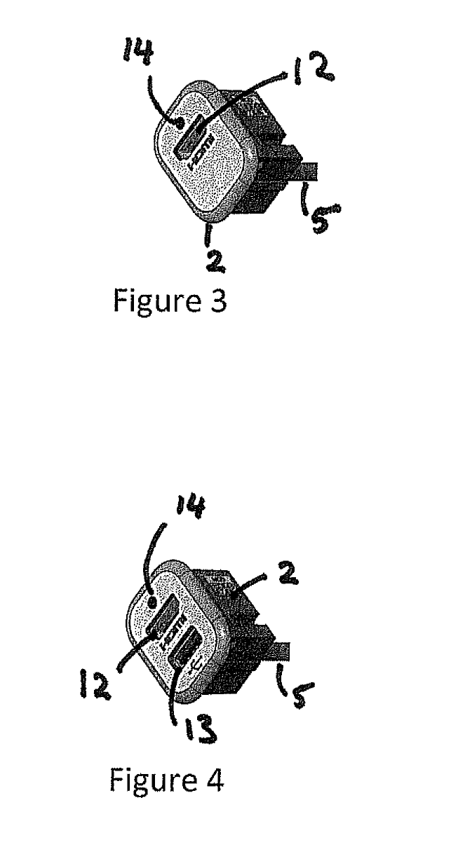

A first embodiment of the converter jack of the present invention is shown in FIG. 3 with a single connection means or input socket, in this case HDMI socket 12, and an indicator 14. In other embodiments the connection means may be an alternative form of socket including, but not limited to USB, ‘Lightning’ or micro-USB.

In an alternative embodiment, illustrated in FIG. 4, there may be multiple sockets to provide data and power connections separately. This may be advantageous if the consumer is using an active converter which requires a data connection and a separate power connection for the converter. Alternatively, a group of connection means may be provided to allow multiple consumer devices to be connected at a single location, either to allow multiple users connecting at the same point of a single user to connect multiple devices.

FIG. 3 also illustrates an indicator 14 on the converter jack. The uses of the indicator include but are not limited to showing the status of the connection, if the device is properly connected, if data transmission is taking place, if it is safe to remove the consumer device, or if there is an error with the converter jack or IFE system. The indicator may be an LED or a small LCD display. In other embodiments there may be more than one indicator present to improve the information provided.

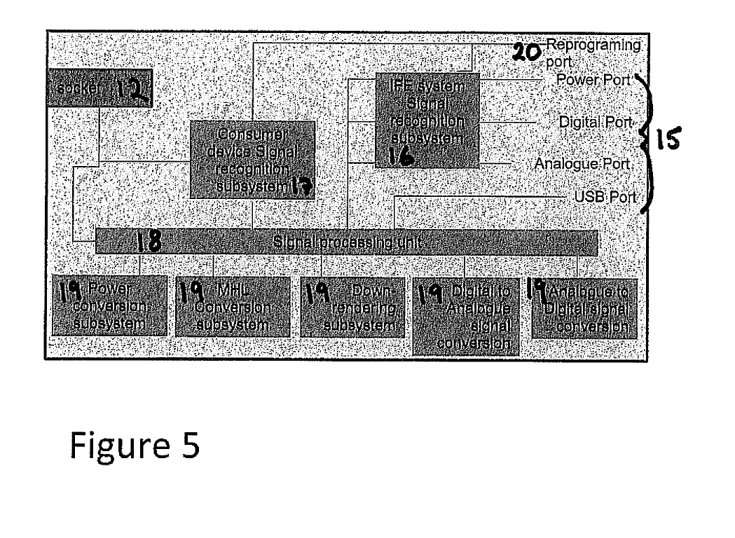

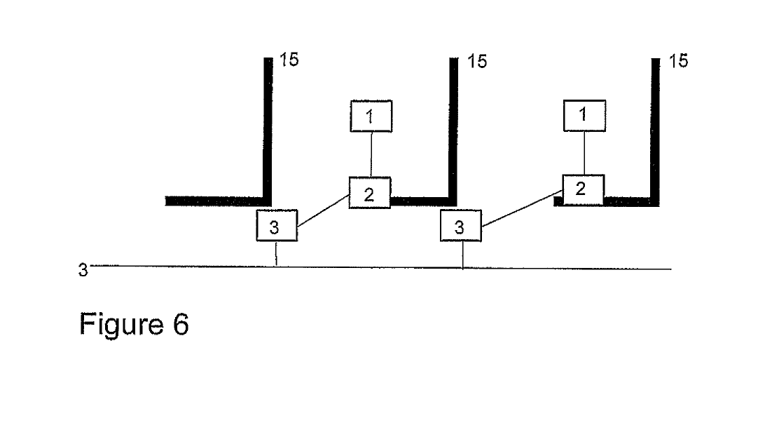

A high level system diagram of the converter jack, shown in FIG. 5, illustrates the ability of the converter jack to interface with different consumer devices. The converter jack is adapted so that the single data input socket 12 (shown as an HDMI port in the preceding figures) is associated with logic, namely a signal recognition sub-system 17, that can recognise the data format of the signal received from a consumer device, and provide the appropriate processing to prepare the signal for the IFE system. In one embodiment the signal recognition sub-system 17 is connected to the socket 12 and the signal processing unit (or signal mixing and switching system) 18 and a reprogramming port 20.

When a consumer device is connected to the input socket 12 of the converter jack the signal recognition sub-system 17 determines the type of signals being received from the device as described in further detail below. The signal processing unit 18 then processes the signal into a form suitable for the IFE server 3. The signal processing unit 18 may have a series of subsystems that are used to process the signals. These may include, but are not limited to a power conversion subsystem, an MHL conversion subsystem, down-rendering subsystem, digital to analogue converter (DAC) subsystem and/or analogue to digital converter (ADC) subsystem.

The signal recognition sub-system 17 may be able to differentiate between signals by one or more of the following techniques:
measuring the voltage levels of the signal at the socket and comparing them to pre-defined limits;
measuring the signals on one or more of the pins of the socket and comparing them to known data standards;
measuring the frequencies of the signals on one or more of the pins of the socket and comparing them to known data standards;
trial and error, by running one or more of a set of decoding algorithms on the signal in succession, and determining if the result is mere noise or coherent data; and/or
displaying options to the user via the IFE system and display, requiring their input selecting the appropriate signal format (or, alternatively, their device).

The appropriate selection of techniques for distinguishing between a plurality of possible signal formats is dependent upon the number and similarity of signals with which interoperability is required. Other technical options for recognising the input signal may also be used without departing from the scope of the invention, and the above techniques are provided by way of non-exhaustive example only.

After a consumer device and signal format has been recognised the signal recognition sub-system 17 may fix the operation of the converter jack, or reduce its recognising processing until an external action, such as removing the cable or a user input suggests that a change in signal format may be occurring.

The signal processing unit 18 shown in FIG. 5 also provides the ability to mix the signals from or to the consumer device 1 so that power, control and one or more data signals may be sent simultaneously. A further advantage of the mixing of the signals is that it allows two way communications between the converter jack 2, the consumer device 1 and the IFE system 3. The signal processing unit also interfaces with the IFE system via one or more input/output ports 5. In one embodiment this interface may be through an IFE signal recognition system 16. The signal processing unit may then apply similar techniques used on the consumer signal to the IFE signal, including the use of the various subsystems, to automatically detect the signal format received from the IFE system. This has an advantage of allowing the converter jack to interface easily with a wide range of IFE systems. Alternatively, the converter jacks may be programmed to operate with a particular IFE system, or may be provided with a switch enabling the converter jack to be physically configured for a particular IFE system upon installation.

The functions of the signal recognition sub-system 17, signal processing unit 18 and IFE recognition sub-system 16 may be combined in a single logic device, such as a single microprocessor or FPGA. Alternatively, the functions of the various sub-systems may be distributed between several hardware logic devices and/or software modules.

The IFE recognition sub-system 16 acts similarly to the signal recognition sub-system 17 associated with the socket 12. It may poll each of the possible inputs 5 from the IFE device, recognise the signal type using methods such as those described previously and supply the appropriate signals to the signal processing unit 18. In a preferred embodiment this process would occur in both directions simultaneously using multiplexing.

As described above the IFE recognition unit may have one or more connections provided to the IFE system. This may require that the recognition of the signals takes place for each of the connections. Alternatively, there may be only a single digital port requiring detection of the digital signal format.

The IFE recognition unit 16 may be connected to the signal processing unit 18, the IFE system 3 and a programming port 20. The connections to the IFE system 5 may consist of a variety of ports including, but not limited to, power, digital, analogue and USB ports. The connector jack may be provided with the specific ports 5 required to communicate with a particular IFE system, or a range of ports which may be selected as required to interface with a number of different IFE systems,

The converter jack is preferably reprogrammable via the reprogramming port 20. This may provide access to the logic of the converter jack through the IFE system or through a separate input sockets. Connecting through the IFE system will allow for one, many or all of the converter jacks to be reprogrammed at once. This may be useful when a new data format has become widely used, or is used by consumer devices that may want to use the system. Alternatively, it may be possible to reprogram the converter jacks individually by connecting an external device directly to the reprograming port. In some cases it may be desirable to allow reprogramming through the input socket 12 directly, although safeguards would need to be present to stop unauthorised access. Programming or reprogramming of the converter jack may update the logic of the signal recognition sub-system 17, the IFE recognition system 16 and/or the signal processing unit 18. Additional subsystems may be added to the signal processing unit as required.

To minimise costs, the processing power of the remote converter jacks may be somewhat limited in comparison to the IFE server system. In some embodiments, some of the processing described herein may be offloaded to the IFE server system. This has the advantage of reducing the hardware requirements and cost of the converter jack and using the greater processing power of the IFE system to convert the signals more effectively. For example when a converter jack is determining a signal format by trial and error, determining whether the result of a particular decoding algorithm is mere noise may be performed by the IFE system. This technique would make further use of the multiplexing of the signals between the converter jack and IFE system.

The input socket of each of the converter jack can preferably be easily removed and replaced as required. This would be advantageous for upgrading the socket means if the technology is superseded. Alternatively IFE systems in different regions may prefer alternative sockets.

From the foregoing it will be seen that a converter jack and IFE system are provided which offer improved flexibility in interfacing with a range of consumer devices using as little as one input socket. The converter jack is able to detect the format of signals received from the consumer device from among a number of possibilities, and thereby facilitates communication between the consumer device and IFE server.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

Although this invention has been described by way of example and with reference to possible embodiments thereof, it is to be understood that modifications or improvements may be made thereto without departing from the scope of the invention. The invention may also be said broadly to consist in the parts, elements and features referred to or indicated in the specification of the application, individually or collectively, in any or all combinations of two or more of said parts, elements or features. Furthermore, where reference has been made to specific components or integers of the invention having known equivalents, then such equivalents are herein incorporated as if individually set forth.

Any discussion of the prior art throughout the specification should in no way be considered as an admission that such prior art is widely known or forms part of common general knowledge in the field.

1. A converter jack facilitating communication between an in-flight entertainment (IFE) system and a consumer device, comprising:
an input socket for receiving signals from the consumer device transmitted in one of a plurality of possible signal formats;
a signal recognition sub-system for detecting the format of the received signals; and
a signal conversion sub-system for converting the received signal to a format appropriate for the IFE system; and
an output for transmitting the converted signal to the IFE system.

2. A converter jack as claimed in claim 1 wherein the signal recognition sub-system is adapted to classify the received signal into one of a plurality of predefined signal formats on the basis of one or more of:
signal voltage levels;
signal frequencies;
pin-outs;
trial and error of decoding algorithms; and/or user input.

3. A converter jack as claimed in claim 1 or claim 2 which may be disconnected from both the consumer devices and the IFE system.
